(19) United States
(12) Patent Application Publication
(10) Pub. No.: US 2008/0086766 A1
(43) Pub. Date: Apr. 10, 2008

(54) CLIENT-BASED PSEUDONYMS

(75) Inventors: Christopher G. Kaler, Sammamish, WA (US); Arun K. Nanda, Sammamish, WA (US); Kim Cameron, Bellevue, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: MICROSOFT CORPORATION, Redmond, WA (US)

(21) Appl. No.: 11/539,255

(22) Filed: Oct. 6, 2006

(51) Int. Cl. H04L 9/32; H04L 9/00; G06F 15/16; H04K 1/00; G06F 17/30; G06F 7/04; G06F 7/58; G06K 19/00; G06K 9/00

(52) U.S. Cl. 726/9; 713/185; 713/172; 713/173; 713/175

(57) ABSTRACT

Obtaining tokens with alternate personally identifying information. A method may be practiced, for example, in a networked computing environment including a client and a token issuer. The token issuer provides security tokens to the client that the client can use for accessing functionality of services in the networked computing environment. The method includes sending a security token request to a token issuer. The security token request specifies alternate personally identifying information for an entity. The method further includes receiving a security token from the security token issuer. The security token includes the alternate personally identifying information.

### BACKGROUND

### Background and Relevant Art

Computers and computing systems have affected nearly every aspect of modern living. Computers are generally involved in work, recreation, healthcare, transportation, entertainment, household management, etc. The functionality of computers has also been enhanced by their ability to be interconnected through various network connections.

Modern computers often include functionality for connecting to other computers. For example, a modern home computer may include a modem for dial-up connection to internet service provider servers, email servers, directly to other computers, etc. In addition, nearly all home computers come equipped with a network interface port such as an RJ-45 Ethernet port complying with IEE 802.3 standards. This network port, as well as other connections such as various wireless and hardwired connections can be used to interconnect computers.

Often, when communicating with one another, computer systems require an authentication process to take place to verify identities and ensure that a computer system has appropriate rights to services being requested. One method of performing this authentication process includes requests for and issuance of security tokens. Security tokens can be presented by a computer system, to a service which has functionality that the computer system desires to access. The security token can be used to verify the identity of the computer system.

Illustrating now an exemplary case, a client system may have use for accessing functionality at a service. However, before accessing the service, the client may request a token from a token issuer service. The token issuer service acts as a third party that is trusted by both the client system and the service which the client wants to access. The token includes personally identifying information for the client in the token that is returned to the client. The token also includes other information such as a certificate, that indicates that the token was issued by the token issuer service. The token can then be presented by the client to the service that the client desires to access. Because the service trusts the token issuer service, the token will be accepted and the services provided to the client.

Generally, the token issuer service has performed some type of authentication with the client prior to the client requesting the token. During this authentication, various pieces of personally identifying information are provided. This information is then later used by the token issuer service to provide the token with the personally identifying information to the client. As such, the personally identifying information that is available to include in a token is limited to pre-defined information available at the token issuer service.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment is illustrated in a method of obtaining tokens. The method may be practiced, for example, in a networked computing environment including a client and a token issuer. The token issuer provides security tokens to the client that the client can use for accessing functionality of services in the networked computing environment. The method includes sending a security token request to a token issuer. The security token request specifies alternate personally identifying information for an entity. The method further includes receiving a security token from the security token issuer. The security token includes the alternate personally identifying information.

In another embodiment viewed from the perspective of a token issuer, a method may be performed in a networked computing environment including a client and a token issuer. The token issuer provides security tokens to the client that the client can use for accessing functionality of services in the networked computing environment. A method of providing tokens includes receiving a security token request from a client. The security token request specifies alternate personally identifying information for an entity. The security token issuer may have stored locally personally identifying information for the entity. A security token is sent to the client, where the security token includes the alternate personally identifying information.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a token request from a client to a token issuer service;

FIG. 1B illustrates a token request from a client to a token issuer service on the client;

FIG. 2 illustrates method of receiving security token requests; and

FIG. 3 illustrates a method of sending security tokens.

### DETAILED DESCRIPTION

Embodiments herein may comprise a special purpose or general-purpose computer including various computer hardware, as discussed in greater detail below.

One embodiment described herein allows for alternate personally identifying information to be transmitted by a client in a request to a token issuer. Because the client has already been authenticated with the token issuer, the token issuer can substitute the alternate personally identifying information in a security token that is issued to the client. As such, information can be included in a security token beyond what is stored at the token issuer as a result of a previous authentication for a given client. Thus, a token issuer can specify alternate personally identifying information in a security token, which in one embodiment can be substituted for personally identifying information that would be included in the security token absent the alternate personally identifying information from the client.

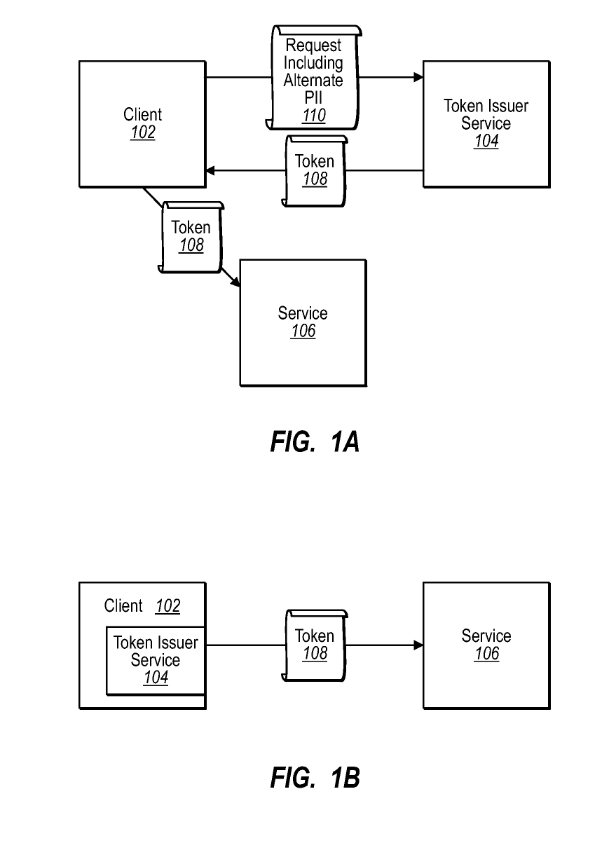

Referring now to FIG. 1A, one embodiment is illustrated. FIG. 1 illustrates a client 102, a token issuer service 104, and a service 106 which includes functionality that the client 102 wishes to access. To access the functionality of the service 106, the client may be required to present a security token 108 to the service 106. The security token 108 can be obtained from the token issuer 104.

In the example illustrated, a request 110 is sent from the client 102 to the token issuer service 104. The request 110 includes alternate personally identifying information. The alternate personally identifying information may be any one of a number of different pieces of information. For example, the personally identifying information may be an alternate email address, an alternate name, a nickname, an alternate telephone number, an alternate physical address, an alternate numeric identifier, etc. Notably, while some examples have been illustrated here, these examples should in no way be considered limiting as to the scope of alternate personally identifying information that may be included.

Returning once again to the example of FIG. 1A, when the token issuer service 104 receives the request 1 10, the token issuer service 104 can respond to the request 110 with a security token 108. The token may include the alternate personally identifying information, other personally identifying information stored at the token issuer service 104, a certificate indicating that the security token 108 was issued by the token issuer service 104, etc.

In one embodiment, when a request for a security token, including alternate personally identifying information is received from a client, a token issuer service may be configured to authenticate the client using personally identifying information at the token issuer. Specifically, because the alternate personally identifying information may not be previously known to the token issuer, the token issuer may perform various authenticating actions to confirm the identity of the client. These authenticating actions may use information previously known about the client by the token issuer service. However, in some alternative embodiments, the information included in the token request may be sufficient to authenticate the client to the token issuer service.

In one exemplary embodiment, the alternate personally identifying information replaces one or more pieces of information from the personally identifying information that would be included in the security token if the alternate personally identifying information were not present in the security token request. For example, a security token 108 that is eventually issued by a token issuer service 104 may exclude certain personally identifying information that would normally be included and replace that information with the alternate personally identifying information included in the token request 110.

Alternatively, the alternate personally identifying information for an entity is an alternative to one or more pieces of information in the personally identifying information for the entity at the security token issuer. For example, a security token 108 issued from a token issuer service 104 may include information that would normally be included absent the inclusion of the alternate personally identifying information in the request 110, but may also include the alternate personally identifying information as well. For example, the security token 108 may include two email addresses instead of a single email address that would normally be included in the token 108.

Some embodiments may be such that the token issuer service is already aware of the alternate personally identifying information. For example, the token issuer service 104 may have four alternate email addresses for a particular client 102. Each of these alternate email addresses may have been authenticated by the token issuer service 104, such that the token issuer service 104 has a reasonable basis for relying on the email addresses as being authentic for the client 102. As such, when the alternate personally identifying information included in the request 110 includes one of the four previously authenticated email addresses, the token issuer service 104 may include the email address specified in the alternate personally identifying information based on having already authenticated the email address.

In an alternative embodiment, the alternate personally identifying information is not pre-registered with the token issuer prior to receiving the alternate personally identifying information in the security token request. Rather, a token issuer may nonetheless include the alternate personally identifying information in a security token by virtue of a security relationship with the client based on primary personally identifying information previously sent.

Referring now to FIG. 1B, an alternative embodiment is illustrated. In the embodiment illustrated in FIG. 1B, the token issuer service 104 is a service included on the client 102. Thus, in this particular example, a token can be obtained locally from a local service. In this particular embodiment, there may be no need to authenticate directly to the service, because it is included as a service on the client and presumably is under the control of the client.

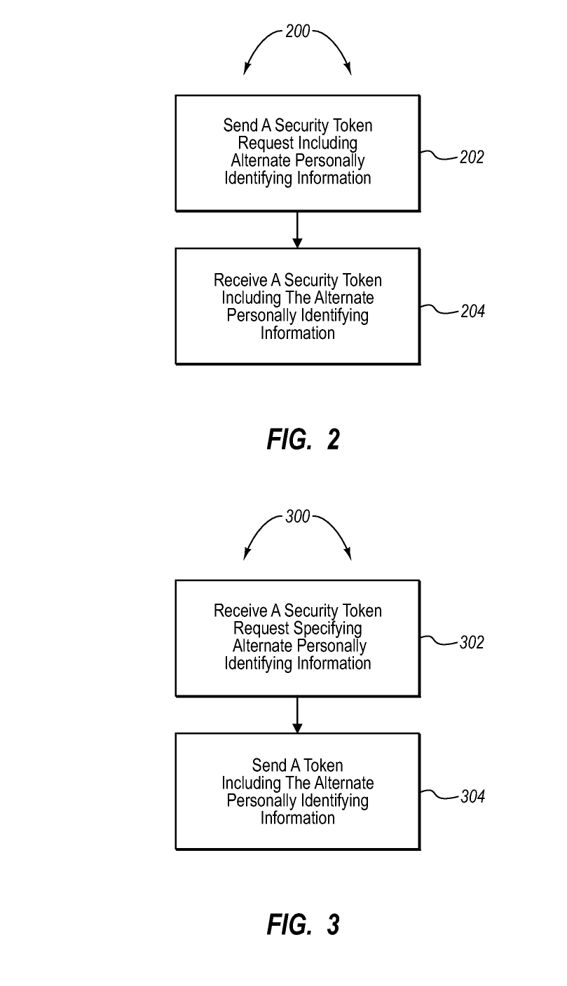

Referring now to FIG. 2, a method 200 is illustrated. The method 200 includes various acts for obtaining tokens. The method 200 may be practiced, for example, in a networked computing environment including a client and a token issuer. The token issuer provides security tokens to the client that the client can use for accessing functionality of services in the networked computing environment.

The method includes sending a security token request including alternate personally identifying information (act 202) for an entity. For example, as illustrated in Figure IA, request 110 is sent to the token issuer service 104. Alternatively, a request may be sent by sending to a local token issuer service 104 such as is illustrated in FIG. 1B.

The method 200 further includes an act of receiving a security token from the security token issuer including the alternate personally identifying information. For example, FIG. 1A illustrates a security token 108 being returned from the token issuer service 104. Alternatively, the security token may be returned from an internal module such as is illustrated in FIG. 1B.

In one embodiment, sending a security token request to a token issuer (act 202) may include sending authentication information authenticating the entity to the token issuer. For example, the authentication information may include personally identifying information at the token issuer that can be used to authenticate the entity to the token issuer. In one embodiment, the authentication information may include an X.509 certificate, a SAML certificate, an XrML certificate and/or Kerberos ticket.

In one embodiment of the method 200, sending and receiving are performed using Web Services. Specifically, Web Services may be used to implement the messaging for token requests and token issuance. Web Services is a standardized way of integrating applications. Standardized XML documents can be used with SOAP (Simple Object Access Protocol) messages and WSDL (Web Services Description Language) descriptions to integrate applications without an extensive knowledge of the applications being integrated. In particular, in one embodiment, WS-Trust, an authentication protocol used in Web Services applications, may be used with the extended functionality of being able to have alternate personally identifying information specified by a client for inclusion in a security token.

Referring now to FIG. 3, a method 300 is illustrated. The method 300 may be practiced, for example, in a networked computing environment including a client and a token issuer. The token issuer provides security tokens to the client that the client can use for accessing functionality of services in the networked computing environment. The method includes various acts for providing tokens. Illustratively, the method includes an act of receiving a security token request from a client specifying alternate personally identifying information (act 302).

The method 300 further includes sending a security token to the client, including the alternate personally identifying information (act 304).

Embodiments may also include computer-readable media for carrying or having computer-executable instructions or data structures stored thereon. Such computer-readable media can be any available media that can be accessed by a general purpose or special purpose computer. By way of example, and not limitation, such computer-readable media can comprise physical media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a networked computing environment including a client and a token issuer, wherein the token issuer provides security tokens to the client that the client can use for accessing functionality of services in the networked computing environment, a method of obtaining tokens, the method comprising:
sending a security token request to a token issuer, wherein the security token request specifies alternate personally identifying information for an entity, and wherein the security token issuer comprises personally identifying information for the entity; and
receiving a security token from the security token issuer, the security token comprising the alternate personally identifying information.

2. The method of claim 1, wherein the alternate personally identifying information replaces one or more pieces of information from the personally identifying information that would be included in the security token if the alternate personally identifying information were not present in the security token request.

3. The method of claim 1, wherein the alternate personally identifying information for an entity is an alternative to one or more pieces of information in the personally identifying information for the entity at the security token issuer.

4. The method of claim 1, wherein the alternate personally identifying information is not pre-registered with the token issuer prior to receiving the alternate personally identifying information in the security token request.

5. The method of claim 1, wherein sending a security token request to a token issuer comprises sending authentication information authenticating the entity to the token issuer, the authentication information including at least a portion of the personally identifying information at the token issuer.

6. The method of claim 5, wherein the authentication information comprises at least one of an X.509 certificate, SAML certificate, XrML certificate or Kerberos ticket.

7. The method of claim 1, wherein the token issuer is a service on a client, wherein the client sends the security token request to the service on the client.

8. The method of claim 1, wherein sending and receiving are performed using Web Services.

9. In a networked computing environment including a client and a token issuer, wherein the token issuer provides security tokens to the client that the client can use for accessing functionality of services in the networked computing environment, a method of providing tokens, the method comprising:
receiving a security token request from a client, wherein the security token request specifies alternate personally identifying information for an entity, and wherein the security token issuer comprises personally identifying information for the entity; and
sending a security token to the client, the security token comprising the alternate personally identifying information.

10. The method of claim 9, wherein the alternate personally identifying information replaces one or more pieces of information from the personally identifying information that would be included in the security token if the alternate personally identifying information were not present in the security token request.

11. The method of claim 9, wherein the alternate personally identifying information for an entity is an alternative to one or more pieces of information in personally identifying information for the entity at the security token issuer.

12. The method of claim 9, wherein the alternate personally identifying information is not pre-registered with the token issuer prior to receiving the alternate personally identifying information in the security token request.

13. The method of claim 9, wherein receiving a security token request comprises receiving authentication information for authenticating the entity.

14. The method of claim 13, wherein the authentication information comprises at least one of an X.509 certificate, SAML certificate, XrML certificate or Kerberos certificate.

15. The method of claim 9, wherein the acts are performed at token issuer which is a service on the client, the client being the client from which the security token request is received.

16. The method of claim 9, wherein sending and receiving are performed using Web Services.

17. A computer readable medium comprising computer executable instructions configured to perform the following acts:
sending a security token request to a token issuer, wherein the security token request specifies alternate personally identifying information for an entity; and
receiving a security token from the security token issuer, the security token comprising the alternate personally identifying information.
